(19) United States
(12) Patent Application Publication
(10) Pub. No.: US 2011/0320712 A1
(43) Pub. Date: Dec. 29, 2011

(54) METHOD AND APPARATUS FOR CONTROLLING STATE OF STORAGE DEVICE AND STORAGE DEVICE

(75) Inventors: Mingjun XU, Chengdu (CN); Yumin DU, Chengdu (CN)

(73) Assignee: CHENGDU HUAWEI SYMANTEC TECHNOLOGIES CO., LTD., Chengdu (CN)

(21) Appl. No.: 13/230,175

(22) Filed: Sep. 12, 2011

Related U.S. Application Data
(63) Continuation of application No. PCT/CN2010/070978, filed on Mar. 11, 2010.

(30) Foreign Application Priority Data
Mar. 12, 2009 (CN) 200910105996.1

(51) Int. Cl. G06F 12/00

(52) U.S. Cl. 711/114; 711/E12.001

(57) ABSTRACT

The embodiments of the present invention provide a method and an apparatus for controlling a state of a storage device, and a storage device, and relate to the field of electronic technologies. State control information of logic disks in the storage device is obtained; it is judged whether the state control information of all the logic disks in the storage device includes sleep instructions; and the storage device is controlled to switch into a sleep state when the state control information of all the logic disks includes the sleep instructions. The technical solutions may effectively control the storage device to switch into the sleep state, overcome the inconvenience of the read and write operations when the storage device automatically switches into the sleep state, and save the power consumption of the storage device with convenient use.

### CROSS-REFERENCE TO RELATED APPLICATIONS

This application is a continuation of International Application No. PCT/CN2010/070978, filed on Mar. 11, 2010, which claims priority to Chinese Patent Application No. 200910105996.1 filed on Mar. 12, 2009, both of which are hereby incorporated by reference in their entireties.

### FIELD OF THE INVENTION

The present invention relates to the field of electronic technologies, and in particular, to a method and an apparatus for controlling a state of a storage device, and a storage device.

### BACKGROUND OF THE INVENTION

With the rapid development of information technology, a data storage volume of a storage device is increasing rapidly. However, an increase in the number of disks in the storage device results in an increase in power consumption of the storage device. Especially in most scenarios, some disk arrays consume a large amount of power while no read and write operation is being performed, thus causing a waste of energy. To solve this problem, a Massive Array of Idle Disks (MAID) was invented. In the MAID technology, if data is seldom read after being written into the disk, a disk that is with a great amount of written data and with no read and write operation is switched into a low power consumption state or even a switch-off state to save electric energy. In addition, an electrical timer switch technology can effectively control the corresponding disk to switch into the low power consumption state. The technology enables the disk to switch into a working state within a particular duration and remain in a sleep state in the rest of time. The disk can only be read and written within the particular duration. However, such a method of limiting the read and write time of the disk brings inconvenience to users.

To solve the problem, a quiet period is set in the conventional art to serve as a reference for determining whether the disk switches into the sleep state, that is, when the time that the disk is not read and written exceeds a silent time threshold, the disk automatically switches into the sleep state.

During the implementation of the present invention, the inventor finds that the conventional art at least has the following problems. After the disk automatically switches into the sleep state, if a host connected to the disk needs to read and write data from the disk that automatically switches into the sleep state, the disk needs to be restarted. However, the restart of the disk consumes a certain period of time, causing a delay of the read and write operations, and brings inconvenience to the read and write of the disk.

### SUMMARY OF THE INVENTION

The present invention is directed to a method and an apparatus for controlling a state of a storage device, and the storage device, so as to overcome inconveniences of read and write operations as the storage device automatically switches into a sleep state.

An embodiment of the present invention provides a method for controlling a state of a storage device, where the method includes:

obtaining state control information of logic disks in the storage device;

judging whether the state control information of all the logic disks in the storage device includes sleep instructions; and

when the state control information of all the logic disks includes the sleep instructions, controlling the storage device to switch into a sleep state.

Another embodiment of the present invention provides an apparatus for controlling a state of a storage device, where the apparatus includes:

an information obtaining module, configured to obtain state control information of logic disks in the storage device;

an information judging module, configured to connect with the information obtaining module and judge whether the state control information of all the logic disks in the storage device includes sleep instructions; and

a sleep control module, configured to obtain a judgment result from the information judging module and control the storage device to switch into a sleep state when the state control information of all the logic disks include the sleep instructions.

Another embodiment of the present invention provides a storage device, where the storage device includes:

an array controller, configured to obtain state control information of logic disks in a disk array group, judge whether the state control information of all logic disks in the disk array group includes sleep instructions, and send a sleep command to the disk array group when the state control information of all the logic disks includes the sleep instructions;

the disk array group, configured to store data, and switch into a sleep state when receiving the sleep command of the array controller.

According to the above described technical solutions, the embodiments of the present invention have the following advantages: obtaining the state control information of the logic disks in the storage device; judging whether the state control information of all the logic disks in the storage device includes the sleep instructions; and controlling the storage device to switch into the sleep state when the state control information of all the logic disks includes the sleep instructions. The technical solutions may effectively control the storage device to switch into the sleep state, overcome the inconveniences of the read and write operations when the storage device automatically switches into the sleep state, and save the power consumption of the storage device with convenient use.

### BRIEF DESCRIPTION OF THE DRAWINGS

FIG. 1 is a flow chart of a method for controlling a state of a storage device according to a first embodiment of the present invention;

FIG. 2 is a schematic diagram of a disk array group in a Redundant Array of Inexpensive Disks (RAID) according to a second embodiment of the present invention;

FIG. 3 is a flow chart of a method for controlling a state of a storage device according to a second embodiment of the present invention;

FIG. 4 is a structural diagram of an apparatus for controlling a state of a storage device according to a third embodiment of the present invention; and

FIG. 5 is a structural diagram of a storage device according to a fourth embodiment of the present invention.

### DETAILED DESCRIPTION OF THE EMBODIMENTS

The technical solution of the present invention will be clearly and completely described in the following with reference to the accompanying drawings. Evidently, the embodiments to be described are only a part rather than all of the embodiments of the present invention. All other embodiments obtained by persons skilled in the art based on the embodiments of the present invention without creative efforts shall fall within the protection scope of the present invention.

It should be noted that the following embodiments are just exemplary embodiments of the present invention, and are not intended to limit the protection scope of the present invention.

### Embodiment 1

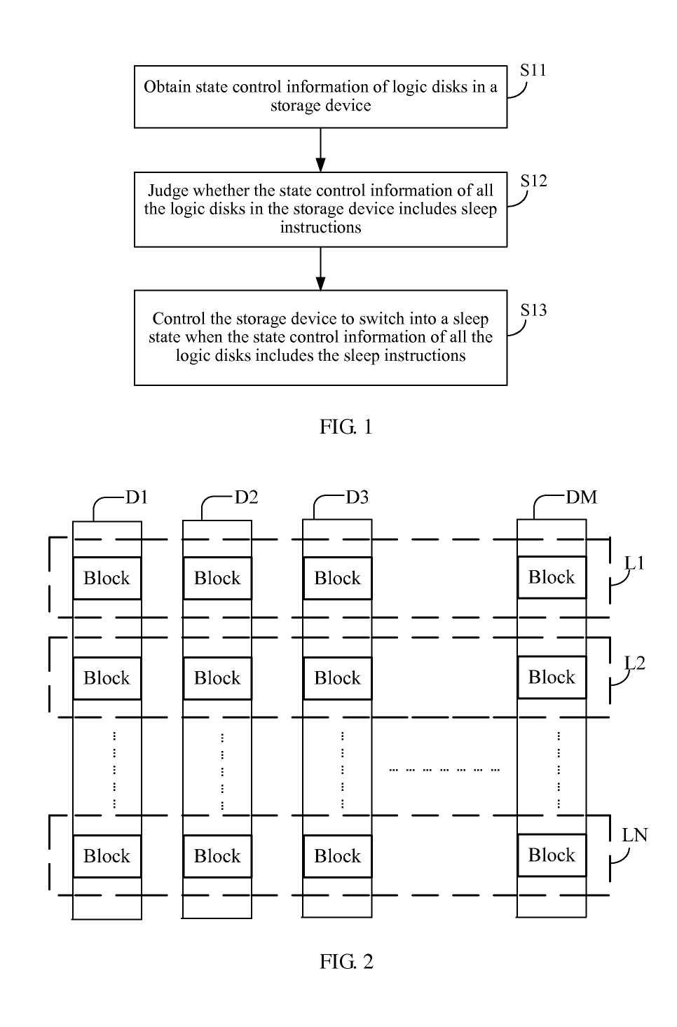

FIG. 1 is a flow chart of a method for controlling a state of a storage device according to a first embodiment of the present invention. The method for controlling the state of the storage device includes the following steps.

In step S11, state control information of logic disks in the storage device is obtained.

In step S12, it is judged whether the state control information of all the logic disks in the storage device includes sleep instructions.

In step S13, when the state control information of all the logic disks includes the sleep instructions, the storage device is controlled to enter a sleep state.

The storage device described in this embodiment has a sleep function, which may control the storage device to switch into the sleep state when a no read and write operation is performed. In this way, power consumption is effectively reduced. The storage device may be a device with a storage function, and the device may be a disk, a computer, or a server. The storage device is made of multiple logic disks, and the logic disks may receive the state control information to control the sleep state of the storage device. In this embodiment, in the way of obtaining and judging the state control information of all the logic disks in the storage device, the storage device is enabled to switch into the sleep state when the state control information of all the logic disks includes the sleep instructions. The above mentioned technical solutions may effectively control the state of the storage device, overcome the inconvenience of the read and write operations when the storage device automatically switches into the sleep state, and save the power consumption of the storage device with convenient use.

### Embodiment 2

To describe a process that a storage device switches into sleep more easily, a disk array is taken as an example in the embodiment of the present invention. In a practical application of the storage device, a disk array may be divided into multiple different disk array groups, and each disk array group may switches into a sleep state as required. The sleep states of the disk array groups do not interfere with each other, that is, the disk array group is generally the smallest physical unit of sleep. FIG. 2 is a schematic diagram of a disk array group in a Redundant Array of Inexpensive Disks (RAID) according to a second embodiment of the present invention. The disk array group includes multiple disks, and these disks are designated as D1, D2, D3, . . . , DM in FIG. 2. The disks are combined together to form a disk array to provide a storage space larger than that of a single disk. The disk array group further includes an array controller for controlling the multiple disks. In the disk array group, each disk is divided into different blocks, and the blocks of different disks are combined to form a Logic Unit Number (LUN) Disk. One disk array group is divided into multiple logic disks, and these logic disks are designated as L1, L2, . . . , LN in FIG. 2. In this way, multiple disks may physically share an operation performed on one logic disk, which not only increases a bandwidth of the disk array group, but also implements a redundant operation among different disks, thereby improving the reliability. The read and write operations on the disk array group are usually performed by a host, where the host may be a server and a minicomputer. The host usually employs a Small Computer System Interface (SCSI) protocol, and is connected to the disk array group through an electric cable or an optical cable. Usually, one disk array group may establish corresponding relationship with multiple hosts, and all hosts perform read and write operations on logic disks in the disk array group rather than actual physical disks. When a disk array group serves multiple hosts, one host usually performs the read and write operation on the corresponding logic disk only, and other logic disks are generally invisible to the host. A sleep or wake-up instruction delivered by the host is required to be effectively functioned on each logic disk of the disk array group, so as to ensure that the host effectively controls the sleep and the working state of the entire disk array group.

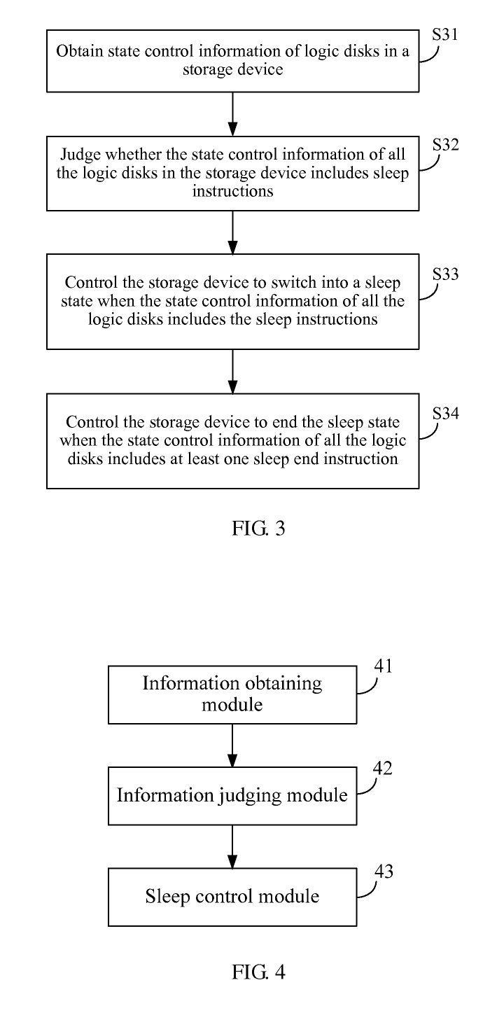

FIG. 3 is a flow chart of a method for controlling a state of a storage device according to a second embodiment of the present invention. The method for controlling the state of the storage device includes the following steps.

In step S31, state control information of logic disks in the storage device is obtained.

A disk array group is taken as an example, and the step may specifically include that an array controller of the disk array group obtains the state control information of the logic disks in the disk array group. The state control information may include a sleep instruction or a sleep end instruction for instructing the logic disk to switch a sleep state or end a sleep state, so as to control the sleep state of the disk array group.

The state control information may be sent to the disk array group from a host connected to the disk array group, so that the host controls the sleep state of the disk array group. As an object of read and write operations performed by the host is the logic disk in the disk array group, the state control information sent by the host is practically for the logic disk used by the host. In this way, all the logic disks in the disk array group may receive the state control information of the corresponding hosts. When the state control information sent by a host includes the sleep instruction, it is indicated that the host allows the corresponding logic disk to switch into the sleep state. When the state control information sent by a host includes the sleep end instruction, it is indicated that the host needs to perform an operation on the corresponding logic disk, and the disk array group corresponding to the logic disk needs to end the sleep state.

In step S32, it is judged whether the state control information of all the logic disks in the storage device includes sleep instructions.

The judging whether the state control information of all the logic disks in the storage device includes the sleep instructions may specifically include: recording the state control information of all the logic disks in the storage device into an instruction register; reading the state control information, recorded in the instruction register, of all the logic disks; and judging whether the state control information of all the logic disks includes the sleep instructions. The state control information may include the sleep instruction or the sleep end instruction for controlling the storage device to switch into the sleep state or end the sleep state.

In the disk array group, the instruction register may be included in the array controller of the disk array group, or may not be included in the array controller. After receiving the state control information, sent by a certain host, of the logic disk in the disk array group, the array controller saves the state control information in the instruction register. The instruction register saves the state control information sent from all the hosts, which are connected to the disk array group, to the corresponding logic disks, so as to subsequently control the sleep state of the disk array group by reading the information. It can be understood by those skilled in the art that, apart from the instruction register, other units each having a storage function may also realize the same function as the instruction register.

It can be understood by those skilled in the art that when it is judged whether the state control information of all the logic disks in the storage device includes the sleep instructions, the register is not necessarily required for saving the state control information of all the logic disks. All the hosts connected to the storage device may report the state control information of the logic disks in real time, and the array controller obtains the state control information of all the logic disks from the corresponding hosts by taking statistics of the report results of all the hosts, thereby omitting an operation of saving the state control information.

The disk array group is still taken as an example here. When the state control information sent by a certain host includes the sleep instruction or the sleep end instruction, where the sleep instruction indicates that the host requests the corresponding logic disk to switch into the sleep state, and the sleep end instruction indicates that the host requests the corresponding logic disk to end the sleep state. However, as the disk array group is usually the smallest physical unit of sleep, it is required to judge the state control information of all the logic disks provided by the corresponding hosts, so as to effectively control the sleep state of the entire disk array group.

The sleep instruction included in the state control information may be set with a sleep level, so as to control the sleep degree of the storage device. In different sleep levels, the power consumption of the storage device is different, and the time needed for restart is also different. In a practical application, according to different power-saving states of the disk array group, the sleep levels of the disk array group may be divided as follows:

Level 0: a normal operation state;

Level 1: a head-off-platter state;

Level 2: a disk speed deceleration state; and

Level 3: a standby/sleep/power-down state.

The sleep levels herein increase in sequence from Level 0, to Level 1, Level 2, and Level 3. Level 0 is the lowest sleep level, indicating that the disk array group is in a normal operation, and Level 3 is the highest sleep level. A higher sleep level indicates that a sleep degree of the disk array group is higher, and that power consumption is further reduced. The host may send the state control information according to different demands of the host to make the disk array group switch into an expected sleep level.

In the above mentioned process, a unit that collects the state control information and controls the sleep state of the disk array group is an array controller. It can be understood by those skilled in the art that, other control units located in the disk array group or a control unit located outside the disk array group (such as a controller, a personal computer (PC), or a server) may also be employed to control the sleep state of the disk array group.

In step S33, when the state control information of all the logic disks includes the sleep instructions, the storage device is controlled to switch into a sleep state.

In this step, the storage device switching into the sleep state may include: when the state control information of all the logic disks includes the sleep instructions, the sleep levels included in all the sleep instructions are compared to obtain the lowest sleep level; and the storage device is controlled to switch into the sleep level corresponding to the lowest sleep level.

The disk array group is taken as an example. When the array controller in the disk array group receives the state control information from all the logic disks, if the array controller finds that all the hosts deliver the sleep instructions in the sent state control information, which indicates that no host needs to perform the read and write operations on the corresponding logic disk, that is, all the logic disks of the disk array group may switch into the sleep state, a sleep operation may be performed on the disk array group.

Because different hosts have different requirements on the corresponding logic disks, the logic disks may be required to switch into different sleep levels. At this time, the sleep levels of the sleep state, which all the hosts allow the corresponding logic disks to switch into, need to be compared, the lowest sleep level is obtained, and the logic disk is allowed to switch into the sleep state corresponding to the lowest sleep level. In this way, a working requirement of the host that delivers the lowest sleep level command is satisfied, thereby avoiding that the requirements of some hosts may not be satisfied because the sleep level of the disk array group is too high.

The method may at least further include step S34: when the state control information of all the logic disks includes at least one sleep end instruction, the storage device is controlled to end the sleep state.

The disk array group is taken as an example. In step S34, if the array controller finds that the state control information of one or more logic disks in the instruction register includes the sleep end instruction, which indicates that one or more hosts require the disk array group to end the sleep state, the array controller may control the disk array group to end the sleep state and start working, so as to satisfy the working requirements of the corresponding host.

In this embodiment, by obtaining and judging the state control information of all the logic disks in the storage device, the storage device is enabled to switch into the sleep state when the state control information of all the logic disks includes the sleep instructions. In this embodiment, the state control information is employed to effectively control the state of the storage device, thus overcoming the inconvenience of the read and write operations when the storage device automatically switches into the sleep state, and saving the power consumption of the storage device with convenient use. In this embodiment, the state control information sent by all the hosts may be saved in the instruction register, so as to subsequently control the sleep state of the storage device by reading the information. In this embodiment, the lowest sleep level in all the sleep instructions can be obtained by comparing all the sleep instructions included in the state control information of all the logic disks, and the storage device switches into the sleep state corresponding to the lowest sleep level to satisfy the working requirements of all the hosts. Meanwhile, the process that the storage device ends the sleep is disclosed in this embodiment. When one or more hosts request the storage device to end the sleep state of storage device, the sleep state of the storage device is ended to satisfy the requirements of the corresponding hosts.

Persons of ordinary skill in the art should understand that a computer program may indicate relevant hardware to implement all or a part of the process of the method according to the embodiments of the present invention. The program may be stored in a computer readable storage medium, such as a magnetic disk, an optical disk, a Read-Only Memory (ROM), or a Random Access Memory (RAM).

### Embodiment 3

FIG. 4 is a structural diagram of an apparatus for controlling a state of a storage device according to a third embodiment of the present invention, and the apparatus includes an information obtaining module 41, an information judging module 42, and a sleep control module 43.

The information obtaining module 41 is configured to obtain state control information of logic disks in the storage device.

The information judging module 42 is configured to connect with the information obtaining module 41 and judge whether the state control information of all the logic disks in the storage device includes sleep instructions.

The sleep control module 43 is configured to obtain a judgment result from the information judging module 42 and control the storage device to switch into a sleep state when the state control information of all the logic disks includes the sleep instructions.

The embodiment provides an apparatus for controlling the state of the storage device. The storage device is controlled to switch into the sleep state according to the state control information of the logic disks in the storage device, thereby facilitating the host to control the state of the storage device through the state control information while saving the power consumption of the storage device.

Furthermore, in the above apparatus embodiment, the sleep control module 43 may further include a sleep level judging submodule and a sleep level control submodule.

The sleep level judging submodule is configured to obtain a judgment result of the information judging module 42, and compare sleep levels in all the sleep instructions when the state control information of all the logic disks includes the sleep instructions, so as to obtain the lowest sleep level.

The sleep level control submodule is configured to connect with the sleep level judging submodule, obtain the lowest sleep level and control the storage device to switch into the sleep state corresponding to the lowest sleep level.

Through the functions of the submodules, the apparatus may select the lowest sleep level from the sleep levels included in the state control information of all the logic disks, and enable the storage device to switch into the sleep level corresponding to the lowest sleep level, so as to ensure that the storage device can satisfy the requirements of all the hosts for the sleep state of the storage device.

Furthermore, the information judging module 42 may include a storage submodule, a read submodule, and a judging submodule.

The storage submodule is configured to connect with the information obtaining module 41 and record the state control information of all the logic disks in the storage device.

The read submodule is configured to read the state control information of all the logic disks recorded in the storage submodule.

The judging submodule is configured to connect with the read submodule and judge whether the state control information of all the logic disks includes the sleep instructions.

Furthermore, the apparatus for controlling the state of the storage device according to Embodiment 3 may further include a sleep end module.

The sleep end module is configured to obtain the judgment result of the information judging module 42, and control the storage device to end the sleep state when the state control information of all the logic disks includes at least one sleep end instruction.

The sleep end module can effectively control the storage device to end the sleep state, so as to make the storage device satisfy the requirement of normal working.

### Embodiment 4

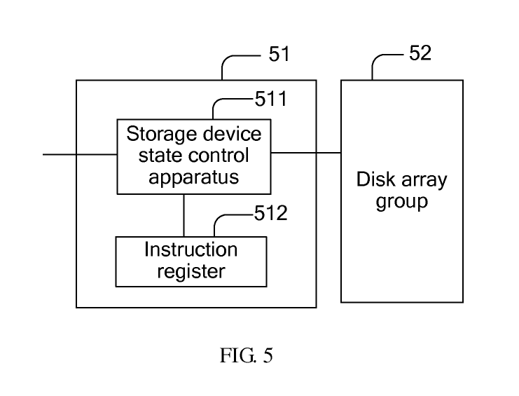

FIG. 5 is a structural diagram of a storage device according to a fourth embodiment of the present invention. The storage device may be connected to multiple hosts to receive the state control information of the multiple hosts, and the storage device includes an array controller 51 and a disk array group 52.

The array controller 51 is configured to obtain the state control information of logic disks in the disk array group 52, judge whether the state control information of all the logic disks in the disk array group 52 includes sleep instructions, and send a sleep command to the disk array group 52 when the state control information of all the logic disks includes the sleep instructions.

The disk array group 52 is configured to store data, and switch into a sleep state when receiving the sleep command of the array controller 51.

In the storage device provided by this embodiment, the array controller controls the sleep state of the disk array group by obtaining the state control information provided by the hosts, so as to ensure that the storage device switches into the sleep state according to requirements of the hosts. In this way, the working requirements of the corresponding hosts may be satisfied, and power consumption may is saved.

Furthermore, the array controller 51 may further include a storage device state control apparatus 511 and an instruction register 512.

The storage device state control apparatus 511 is configured to obtain the state control information of the logic disks in the disk array group 52, store the state control information of all the logic disks in the disk array group 52 into the instruction register 512, read the state control information of all the logic disks recorded in the instruction register 512, judge whether the state control information of all the logic disks includes the sleep instructions, send the sleep command to the disk array group 52 when the state control information of all the logic disks includes the sleep instructions, and send a sleep end command to the disk array group 52 when the state control information of all the logic disks includes at least one sleep end instruction.

The instruction register 512 is configured to record the state control information of all the logic disks.

The storage device state control apparatus in the array controller may save the state control information obtained from the multiple hosts into the instruction register to facilitate statistics and management of the information, so as to make the array controller control the disk array group to switch into the sleep state more conveniently.

Persons of ordinary skill in the art can understand that, the modules in the apparatus embodiment may be hardware or software, and may be independent modules or modules that can be combined or separated to realize the same function with each module.

In conclusion, the present invention provides a method and an apparatus for controlling a state of a storage device and a storage device. The state control information of the logic disks in the storage device is obtained, it is judged whether the state control information of all the logic disks in the storage device includes the sleep instructions, and the storage device is controlled to switch into the sleep state when the state control information of all the logic disks includes the sleep instructions. Through the above mentioned technical solutions, the state of the storage device is effectively controlled, the inconvenience of the read and write operations is shaken off when the storage device automatically switches into the sleep state, and the power consumption of the storage device is saved with convenient use. In this embodiment, the state control information provided by all the hosts may be saved in the instruction register, so as to subsequently control the storage device by reading the information. In this embodiment, the lowest sleep level in all the sleep instructions can be obtained by comparing all the sleep instructions included in the state control information of all the logic disks, so as to make the storage device switch into the sleep state corresponding to the lowest sleep level to satisfy the working requirements of all the hosts. Meanwhile, the process and the relevant hardware for the storage device to end a sleep state are disclosed in this embodiment. When one or more hosts request the storage device to end the sleep state of storage device, the sleep state of the storage device is ended to satisfy the working requirements of the corresponding hosts. The level embodiment of the present invention further provides a storage device, which receives the state control information provided by the hosts through connections to the hosts, and switches into the sleep state as required. In this way, the working requirements of the hosts are satisfied, and the power consumption is saved.

What is claimed is:

1. A method for controlling a state of a storage device, comprising:
obtaining state control information of logic disks in the storage device;
judging whether the state control information of all the logic disks in the storage device comprises sleep instructions; and
controlling the storage device to switch into a sleep state when the state control information of all the logic disks comprises the sleep instructions.

2. The method according to claim 1, wherein the state control information of the logic disks is sent to the storage device through hosts connected to the storage device, and the state control information comprises the sleep instruction or a sleep end instruction.

3. The method according to claim 1, wherein before the judging whether the state control information of all the logic disks in the storage device comprises the sleep instructions, the method further comprises:
recording, into an instruction register, the state control information of all the logic disks in the storage device; and
reading the state control information, recorded in the instruction register, of all the logic disks.

4. The method according to claim 1, wherein the controlling the storage device to switch into the sleep state comprises:
comparing sleep levels in all the sleep instructions to obtain a lowest sleep level; and
controlling the storage device to switch into the sleep state corresponding to the lowest sleep level.

5. The method according to claim 1, further comprising:
controlling the storage device to end the sleep state when the state control information of all the logic disks comprises at least one sleep end instruction.

6. An apparatus for controlling a state of a storage device, comprising:
an information obtaining module, configured to obtain state control information of logic disks in a storage device;
an information judging module, configured to connect with the information obtaining module and judge whether the state control information of all the logic disks in the storage device comprises sleep instructions; and
a sleep control module, configured to obtain a judgment result from the information judging module, and control the storage device to switch into a sleep state when the state control information of all the logic disks comprises the sleep instructions.

7. The apparatus according to claim 6, wherein the sleep control module comprises:
a sleep level judging submodule, configured to obtain a judgment result of the information judging module, and compare sleep levels comprised in all the sleep instructions to obtain a lowest sleep level when the state control information of all the logic disks comprises the sleep instructions; and
a sleep level control submodule, configured to connect with the sleep level judging submodule, obtain the lowest sleep level and control the storage device to switch into the sleep state corresponding to the lowest sleep level.

8. The apparatus according to claim 6, wherein the information judging module comprises:
a storage submodule, configured to connect with the information obtaining module and record the state control information of all the logic disks in the storage device;
a read submodule, configured to read the state control information, recorded in the storage submodule, of all the logic disks; and
a judging submodule, configured to connect with the read submodule, and judge whether the state control information of all the logic disks comprises the sleep instructions.

9. The apparatus according to claim 6, further comprising:
a sleep end module, configured to obtain a judgment result of the information judging module, and control the storage device to end the sleep state when the state control information of all the logic disks comprises at least one sleep end instruction.

10. A storage device, comprising:
an array controller, configured to obtain state control information of logic disks in a disk array group, judge whether the state control information of all the logic disks in the disk array group comprises sleep instructions, and send a sleep command to the disk array group when the state control information of all the logic disks comprises the sleep instructions; and
the disk array group, configured to store data, and switch into a sleep state when receiving the sleep command of the array controller.

11. The storage device according to claim 10, wherein the array controller comprises:
a storage device state control apparatus, configured to obtain the state control information of the logic disks in the disk array group, store the state control information of all the logic disks in the disk array group into an instruction register, read the state control information, recorded in the instruction register, of all the logic disks, judge whether the state control information of all the logic disks comprises the sleep instructions, send the sleep command to the disk array group when the state control information of all the logic disks comprises the sleep instructions, and send the sleep end command to the disk array group when the state control information of all the logic disks comprises at least one sleep end instruction; and
the instruction register, configured to record the state control information of all the logic disks.
